(19) United States
(12) Patent Application Publication
(10) Pub. No.: US 2014/0340907 A1
(43) Pub. Date: Nov. 20, 2014

(54) LED LAMP WITH COVER

(71) Applicants: Foxconn Technology Co., Ltd., New Taipei (TW); CHAMP TECH OPTICAL (FOSHAN) CORPORATION, Foshan (CN)

(72) Inventors: GUANG YU, Foshan (CN); QIAN XIANG, Foshan (CN)

(73) Assignees: FOXCONN TECHNOLOGY CO., LTD., New Taipei (TW); CHAMP TECH OPTICAL (FOSHAN) CORPORATION, Foshan (CN)

(21) Appl. No.: 13/972,848

(22) Filed: Aug. 21, 2013

(30) Foreign Application Priority Data
May 17, 2013 (CN) 2013101820978

(51) Int. Cl. F21V 3/00

(52) U.S. Cl. CPC F21V 3/005
USPC 362/294

(57) ABSTRACT

An LED lamp includes a housing and multiple LED units received in the housing. Each LED unit includes a heat sink, multiple LEDs mounted below the heat sink and a cover overlaying the heat sink. The heat sink includes a base and multiple fins extending upwardly from the base. The cover includes a supporting plate defining multiple openings corresponding to the fins, and multiple shading tabs connected to the supporting plate. Each shading tab covers one opening and forms an airflow passage communicating the opening with an outside environment atmosphere.

### BACKGROUND

1. Technical Field

The disclosure generally relates to LED (light emitting diode) lamps, and particularly to an LED lamp with covers to protect heat dissipation fins thereof.

2. Description of Related Art

LEDs (light emitting diodes) are widely used in various for illumination. A typical LED lamp includes a housing, a plurality of LEDs received in the housing and a plurality of fins mounted in the housing. The fins are in thermal contact with the LEDs for dissipating heat from the LEDs to an outside environment.

However, the fins are generally exposed in the outside environment directly. Therefore, the fins are easily polluted by outside contamination such as bird's dropping. The outside contamination covering the fins will adversely affect heat dissipation of the fins.

What is needed, therefore, is an LED lamp with covers which can address the limitations described above.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 is an assembled view of an LED lamp in accordance with an embodiment of the present disclosure.

FIG. 2 is an exploded view of the LED lamp of FIG. 1.

FIG. 3 is an inverted view of the LED lamp of FIG. 2.

### DETAILED DESCRIPTION

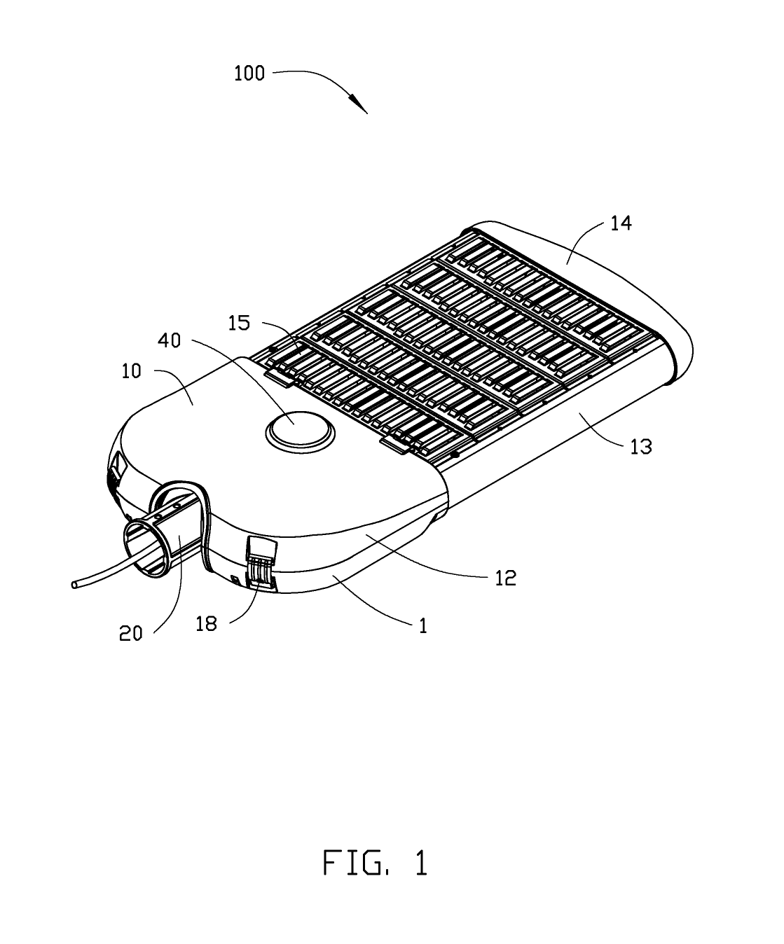

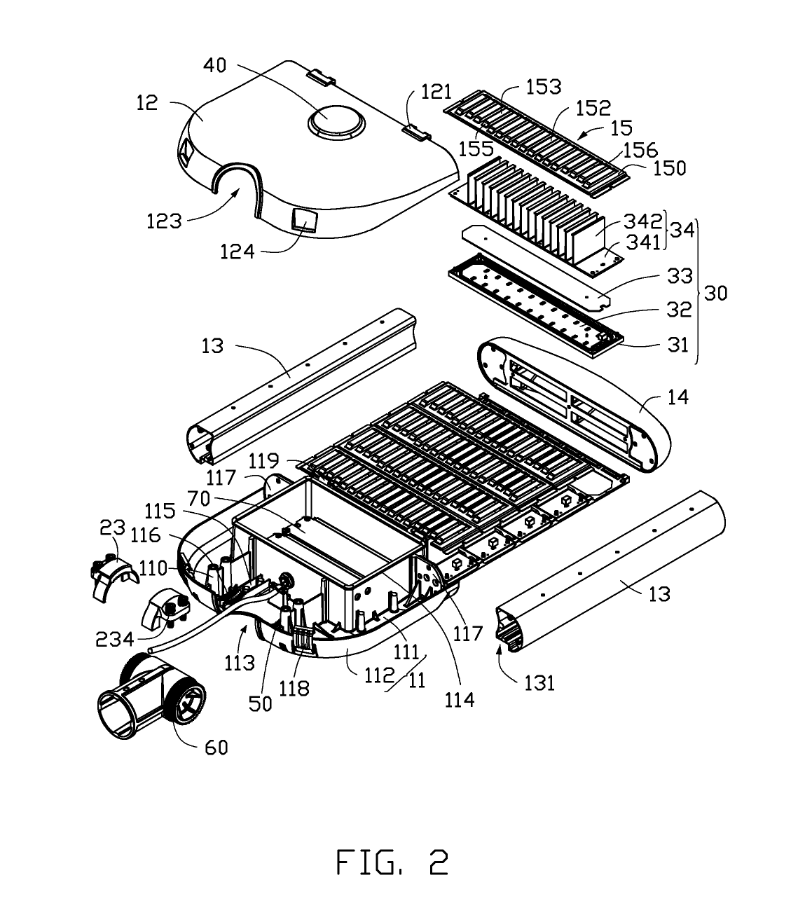

Referring to FIGS. 1-2, an LED lamp 100 in accordance with an embodiment of the present disclosure is shown. The LED lamp 100 includes a housing 10, a connector 20 connected to the housing 10 and a plurality of LED units 30 received in the housing 10.

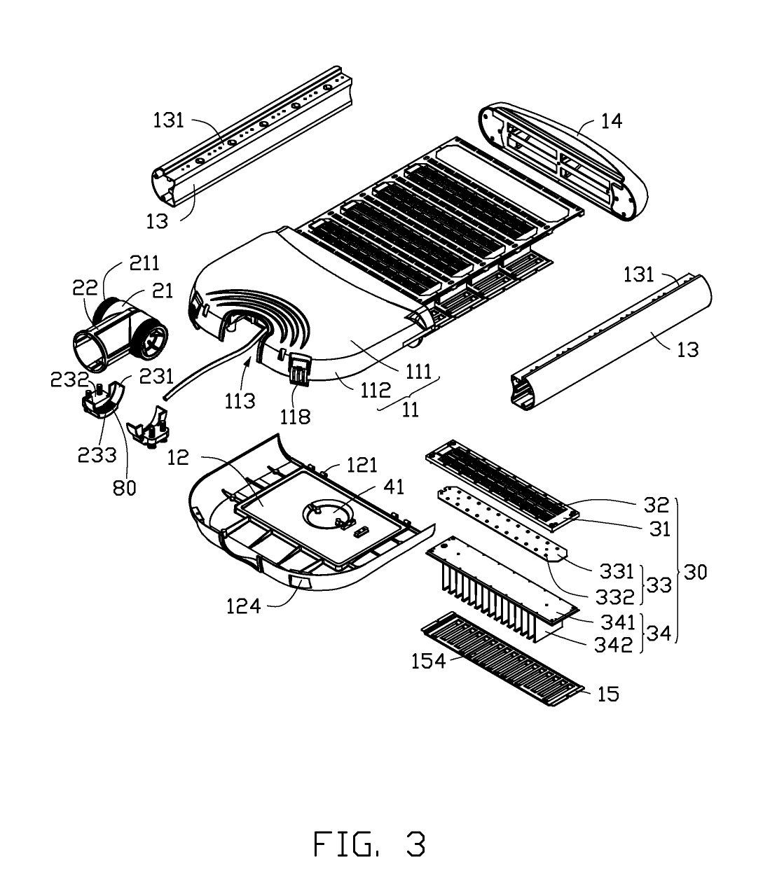

Also referring to FIG. 3, the housing 10 includes a frame 11 and a lid 12 pivotably connected to the frame 11. The frame 11 includes a bottom plate 111 and a sidewall 112 extending upwardly from an outer periphery of the bottom plate 111. A cutout 113 is defined in a rear end of the frame 11. The cutout 113 extends through the sidewall 112 and the bottom plate 111. A chamber 114 is formed on a top face of the bottom plate 111 to receive a driving module 70. Two hinges 119 are formed on a top of the chamber 114 adjacent to a front end of the frame 11. Two ribs 115 protrude upwardly from the top face of the bottom plate 111 in a manner that the cutout 113 is located between the two ribs 115. The two ribs 115 are located at the rear end of the frame 11 and adjacent to the cutout 113. Each rib 115 interconnects the sidewall 112 and the chamber 114. Each rib 115 forms a plurality of teeth 116 on a top face thereof. The teeth 116 of each rib 115 are arranged curvedly and thus form a concave gear 50. Four studs 110 are formed on the top face of the bottom plate 111, wherein two studs 110 are located adjacent to one rib 115, and the other two studs 110 are located adjacent to the other rib 115. The two ribs 115 are located between the four studs 110. Two mounting plates 117 are formed on the bottom plate 111 in a manner that the chamber 114 is located between the two mounting plates 117. The two mounting plates 117 are located at the front end of the frame 11. Each mounting plate 117 also interconnects the sidewall 112 with the chamber 114. Two elastically deformable buckles 118 are connected to the sidewall 112. The two buckles 118 are located at two opposite sides of the cutout 113.

The lid 12 covers the frame 11. The lid 12 includes a cutout 123 defined in a rear end thereof. The cutout 123 of the lid 12 and the cutout 113 of the frame 11 cooperatively enclose a circular hole to receive the connector 20. Two hinges 121 are formed on a front end of the lid 12. The two hinges 121 of the lid 12 can be engaged with the two hinges 119 of the frame 11 to enable the lid 12 pivotably connected to the frame 11. Therefore, the lid 12 can be conveniently open or closed by rotating the lid 12 away from or towards the frame 11, thereby facilitating access of the driving module 70 or other elements within the housing 10. Two depressions 124 are defined in the rear end of the lid 12. The two depressions 124 are located at two opposite sides of the cutout 123. The two buckles 118 can be locked in the two depressions 124 to fix the lid 12 with the frame 11. A light sensor 40 is mounted on a top face of the lid 12. The light sensor 40 is electrically connected to the driving module 70. The light sensor 40 can detect light variation of an outside environment, thereby automatically controlling the LED units 30 to switch on or off via the driving module 70.

The connector 20 includes a first tube 22 and a second tube 21 perpendicularly connected to the first tube 22. The first tube 22 is used to engage with a lamp pole to fix the LED lamp 100 to the lamp pole. The second tube 21 forms a plurality of teeth 211 on two opposite ends thereof. The teeth 211 on each end of the second tube 21 construct an annular gear 60 with outer teeth 211. Two brackets 23 are further provided to fix the connector 20 with the frame 11. The two brackets 23 are located corresponding to the two ribs 115 of the frame 11. Each bracket 23 includes a block 232 and a flange 231 connected to the block 232. The flange 231 is curved and forms a plurality of teeth 233 on a bottom face thereof. The teeth 233 of the flange 231 cooperatively form a concave gear 80. The concave gear 80 of each bracket 23 and the concave gear 50 of a corresponding rib 115 cooperatively construct an annular gear with inner teeth 116, 233. The second tube 21 can be sandwiched between the two ribs 115 and the flanges 231 of the two brackets 23 such that the annular gear 60 with the outer teeth 211 is engaged with the annular gear with the inner teeth 116, 233. An engagement between the teeth 116, 211, 233 of the two annular gears 60 can facilitate an illumination angle adjustment of the housing 10 relative to the connector 20. The housing 10 can be conveniently rotated around the connector 20 to enable the LED units 30 towards different orientations, thereby meeting different illumination requirements.

Each bracket 23 has two screws 234 extending through the block 232 thereof into two corresponding studs 110 of the frame 11, whereby each bracket 23 is fixed on the frame 11. The teeth 211 of the second tube 21 of the connector 20 is pressed and confined by the teeth 116, 233 of the ribs 115 and the brackets 23 after the brackets 23 are fixed on the frame 11, whereby the connector 20 is also fixed with the frame 11 by an interfering engagement between the teeth 116, 211, 233. When the housing 10 is required to change an illumination angle, the screws 234 of the brackets 23 are firstly loosen, and the housing 10 is then rotated around the second tube 21 of the connector 20. When the housing 10 reaches the required illumination angle, the screws 234 of the brackets 23 are tighten, thereby fixing the housing 10 with the connector 20. A large number of the teeth 116, 211, 233 of the ribs 115, the connector 20 and the brackets 23 can achieve precise rotation of the housing 10 relative to the connector 20, whereby the housing 10 can be adjusted to have an accurate illumination angle.

A head 14 is disposed opposite to the frame 11. The head 14 and the frame 11 are located at a front end and a rear end of the LED lamp 100, respectively. Two parallel arms 13 interconnect the head 14 and the frame 11. Each arm 13 is fixed to a corresponding mounting plate 117 via screws. Each arm 13 is also fixed to the head 14 via screws. Each arm 13 forms a step 131 in a bottom thereof for mounting the LED units 30 thereon. In this embodiment, each arm 13 is hollow to reduce a weight thereof.

The LED units 30 are arranged between the frame 11 and the head 14. The LED units 30 are arranged parallel to each other. Each LED unit 30 includes a heat sink 34, an LED module 33 mounted on the heat sink 34, a panel 31 fixed to the heat sink 34, a plurality of lens 32 secured to the panel 31 and a cover 15 overlaying the heat sink 34. The heat sink 34 may be made of metal such as copper or aluminum. The heat sink 34 includes a base 341 and a plurality of fins 342 extending upwardly from a top face of the base 341. Two opposite ends of the base 341 of each LED unit 30 is disposed on bottom faces of the steps 131 of the two arms 13 and fixed to the steps 131 by screws. The LED module 33 includes a circuit board 331 and a plurality of LEDs 332 mounted on the circuit board 331. The circuit board 331 is fixed on a bottom face of the base 341. The circuit board 331 has an area less than that of the base 341. The circuit board 331 is electrically connected to the driving module 70. The LEDs 332 are fixed on a bottom face of the circuit board 331. The LEDs 332 are electrically connected to the circuit board 331. The LEDs is controlled by the driving module 70 via the circuit board 331. Heat generated by the LEDs 332 can be conducted by the base 341 to the fins 342 through the circuit board 331. The panel 31 and the lens 32 are integrally made of a single monolithic piece of transparent material such as silicone or epoxy. The panel 31 is fixed on the bottom face of the base 341 to cover the LEDs 332. Each lens 32 is located corresponding to one LED 332. Thus, light emitted from the LEDs 332 can be adjusted by the lens 32 to produce a desired light distribution.

The cover 15 is made of a single monolithic piece of metal material such as copper of aluminum. The cover 15 includes a supporting plate 150 and a plurality of shading tabs 152 formed on the supporting plate 150. The supporting plate 150 defines a plurality of openings 154 corresponding to the fins 342. Two opposite ends of the supporting plate 150 is disposed on top faces of the two arms 13 and fixed to the two arms 13 by screws. Each shading tab 152 is bended upwardly from the supporting plate 150 such that each shading tab 152 has two opposite ends connected to two opposite short edges of a corresponding opening 154, and two opposite sides spaced from two opposite long edges of the corresponding opening 154. Each shading tab 154 includes a flat section 153 parallel to the supporting plate 150 and two opposite inclined sections 155 connecting the flat section 153 with the supporting plate 150. Each shading tab 152 covers a corresponding opening 154 for preventing outside contamination from being dropped on the fins 342 directly. Thus, heat dissipation of the heat sink 34 will not be affected by the outside contamination. Furthermore, each shading tab 152 is located above the corresponding opening 154 such that airflow passages 156 are formed between the shading tabs 152 and the supporting plate 150. The airflow passages 156 communicate with the openings 154 so that heat conducted by the fins 342 can be effectively dissipated by airflow circulation through the openings 154 and the airflow passages 156.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED (light emitting diode) lamp comprising:
a housing;
an LED unit comprising:
a heat sink comprising a base fixed to the housing and a plurality of fins extending from the base;
an LED mounted to the base; and
a cover comprising a supporting plate defining a plurality of openings and a plurality of shading tabs connected to the supporting plate, the openings being located corresponding to the fins, respectively;
wherein each shading tab covers a corresponding opening, an airflow passage is defined between each shading tab and the supporting plate to communicate the corresponding opening with an outside environment atmosphere.

2. The LED lamp of claim 1, wherein each shading tab is located above the corresponding tab.

3. The LED lamp of claim 1, wherein each shading tab comprises a flat section parallel to the supporting plate and two inclined sections connecting the flat section with the supporting plate.

4. The LED lamp of claim 1, wherein the cover is made of a single monolithic piece of metal.

5. The LED lamp of claim 1, wherein the housing comprises a frame and a lid pivotably connected to the frame.

6. The LED lamp of claim 5, wherein the frame comprises a bottom plate and a chamber formed on the bottom plate, a driving module being received in the chamber.

7. The LED lamp of claim 6, wherein the frame comprises two mounting plates formed on the bottom plate and connecting the chamber, the chamber being located between the two mounting plates.

8. The LED lamp of claim 7, wherein the housing further comprises two arms respectively fixed to the two mounting plates, the LED unit being fixed to the two arms.

9. The LED lamp of claim 8, wherein each arm forms a step at a bottom thereof, two opposite ends of the base being disposed on and fixed to the steps of the two arms, and two opposite ends of the supporting plate of the cover being disposed on and fixed to tops of the two arms, respectively.

10. The LED lamp of claim 6, wherein the frame comprises a hinge formed on a top of the chamber, and the lid comprises a hinge pivotably connected to the hinge of the frame.

11. The LED lamp of claim 6, wherein the frame comprises a sidewall extending from the bottom plate towards the lid and a buckle formed on the sidewall, and the lid comprises a depression locking with the buckle.

12. The LED lamp of claim 6, wherein the lid comprises a light sensor electrically connected to the driving module.

13. The LED lamp of claim 6 further comprising a connector sandwiched between the lid and the frame, wherein the frame is rotatable relative to the connector.

14. The LED lamp of claim 13, wherein the connector comprises a first tube inserted into the frame and a second tube engaging with the frame.

15. The LED lamp of claim 14, wherein the first tube is perpendicular to the second tube.

16. The LED lamp of claim 14, wherein the second tube forms a plurality of teeth on each end thereof, and the frame comprises two ribs formed on the bottom plate, each rib having a plurality of teeth interferingly engaging with the teeth of a corresponding end of the second tube.

17. The LED lamp of claim 16 further comprising two brackets fixing the connector with the frame, wherein each bracket comprises a flange having a plurality of teeth interferingly engaging with the teeth of a corresponding end of the second tube.

18. The LED lamp of claim 17, wherein the teeth of the second tube form a first annular gear with outside teeth.

19. The LED lamp of claim 18, wherein the teeth of each rib and a corresponding bracket cooperatively form a second annular gear with inside teeth, the first annular gear with the outside teeth being surrounded by the second annular gear with the inside teeth.

20. The LED lamp of claim 17, wherein each bracket further comprises a block connected to the flange thereof, and the frame forms a plurality of studs protruding from the bottom plate thereof, the block of each bracket being fixed on a corresponding stud by a screw.
